(19) United States
(12) Patent Application Publication
(10) Pub. No.: US 2010/0263046 A1
(43) Pub. Date: Oct. 14, 2010

(54) SECURITY WRAPPER METHODS AND SYSTEMS

(75) Inventor: Raghunadh Polavarapu, San Antonio, TX (US)

Correspondence Address: Cantor Colburn LLP - Fox Entertainment Group, 20 Church Street, 22nd Floor, Hartford, CT, 06103, US

(73) Assignee: MYSPACE, INC., Beverly Hills, CA (US)

(21) Appl. No.: 12/757,282

(22) Filed: Apr. 9, 2010

Related U.S. Application Data
(60) Provisional application No. 61/168,023, filed on Apr. 9, 2009.

(51) Int. Cl. G06F 11/00

(52) U.S. Cl. 726/22

(57) ABSTRACT

In one example, a web content security system embedded in a computer-usable storage medium that identifies potential threats when executed by one or more processors is provided. The web content security system includes a communications monitor module that monitors at least one of data communications between web objects on a web page and data communications between web objects on a web page and a server, and that identifies a potential threat based on the data communications. A logger module generates report data based on the identified potential threat.

### CROSS-REFERENCES TO RELATED APPLICATIONS

This patent application claims priority to US Provisional Patent Application Ser. No. 61/168023, filed Apr. 9, 2009 which is incorporated herein by reference in its entirety.

### FIELD

The present disclosure relates to security methods, systems, and computer program products for internet content.

### BACKGROUND

Web-based advertisements have become increasingly popular. Advertisements can be provided in varying forms including video clips, animations, and/or static images. The advertisements can be displayed by a web page by dynamically integrating a specific advertisement into a static display object or a video object. The dynamic integration allows for various advertisements to be displayed by the web page without altering the web page each time a new advertisement is displayed.

In some instances, security of the advertisement objects is compromised when unknown sources script to and redirect the web browser so that an advertisement from a third party supplier can be loaded into and displayed by the objects. Detection and prevention of such intrusions is desirable.

### SUMMARY

Accordingly, in one example, a web content security system embedded in a computer-usable storage medium that identifies potential threats when executed by one or more processors is provided. The web content security system includes a communications monitor module that monitors at least one of data communications between web objects on a web page and data communications between web objects on a web page and a server, and that identifies a potential threat based on the data communications. A logger module generates report data based on the identified potential threat.

Further areas of applicability will become apparent from the description provided herein. It should be understood that the description and specific examples are intended for purposes of illustration only and are not intended to limit the scope of the present disclosure.

### BRIEF DESCRIPTION OF THE SEVERAL VIEWS OF THE DRAWINGS

The drawings described herein are for illustration purposes only and are not intended to limit the scope of the present disclosure in any way. It should be understood that throughout the drawings, corresponding reference numerals indicate like or corresponding parts and features.

FIG. 1 is a block diagram illustrating a computing system that includes a content security management system in accordance with an exemplary embodiment of the present disclosure.

FIG. 2 is a block diagram illustrating a web page including a content security manager in accordance with an exemplary embodiment.

FIG. 3 is a dataflow diagram illustrating the content security manger of FIG. 2 in accordance with an exemplary embodiment.

FIGS. 4A-4C are illustrations of exemplary implementations of the content security manager of FIG. 2 for a video player of the web page in accordance with an exemplary embodiment.

FIGS. 5A-5B are illustrations of exemplary implementations of the content security manger of FIG. 2 for web objects of the web page in accordance with an exemplary embodiment.

FIG. 6 is a flowchart illustrating a security method that can be implemented by the content security manager of FIG. 3 in accordance with an exemplary embodiment.

### DETAILED DESCRIPTION

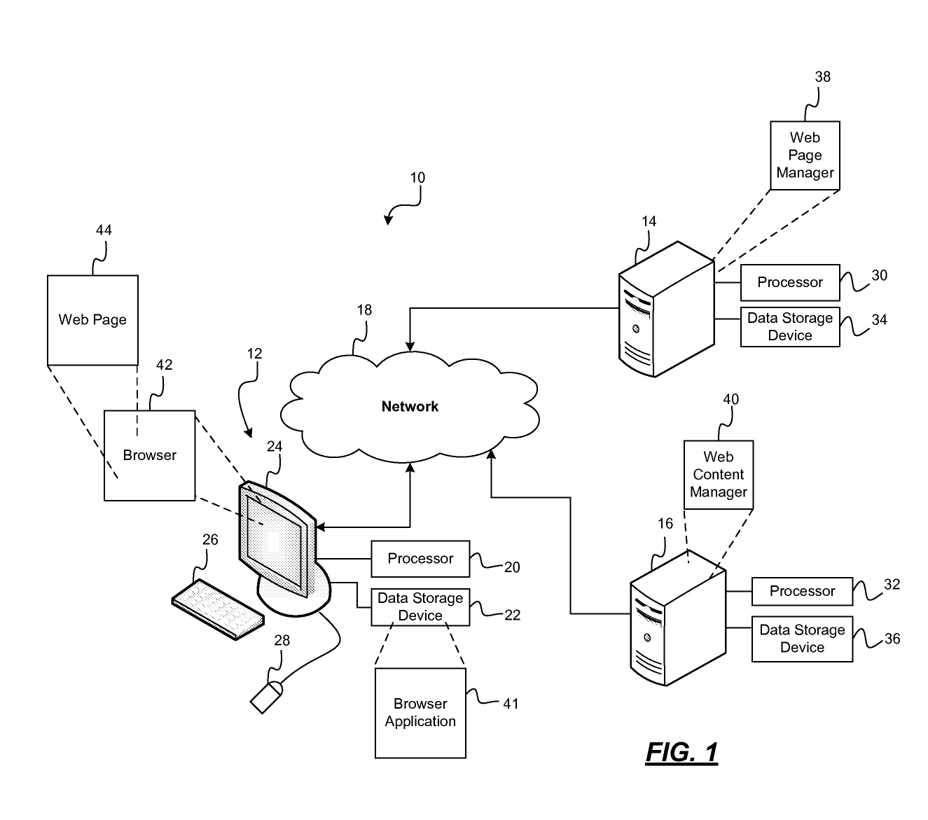

Turning now to the drawings in greater detail, it will be seen that in FIG. 1 an exemplary computing system 10 includes a content security management system of the present disclosure. The exemplary computing system 10 is shown to include a computer 12 that communicates with one or more servers 14, 16 via a network 18. The computer 12 includes a processor 20 and one or more data storage devices 22. The processor 20 can be any custom made or commercially available processor, a central processing unit (CPU), an auxiliary processor among several processors associated with the computer, a semiconductor based microprocessor (in the form of a microchip or chip set), a macroprocessor, or generally any device for executing software instructions. The one or more data storage devices 22 can be any internal or external data storage devices including, but not limited to, random access memory (RAM), read only memory (ROM), a cache, a stack, or the like which may temporarily or permanently store electronic data of the computer 12.

As can be appreciated, the computer 12 can be any computing device that includes a processor 20 and a data storage device 22, including, but not limited to, a desktop computer, a laptop, a workstation, a cell phone, and a personal handheld device. The computer 12 is shown to be associated with a display 24 and one or more input devices 26, 28 that can be used by a user to communicate with the computer 12. As can be appreciated, such input devices 26, 28 can include, but are not limited to, a mouse, a keyboard, and a touchpad.

The data storage device 22 stores software instructions of a browser application 41 and the processor 20 executes the instructions of the browser application 41. The browser application 41 generates a web browser 42 that is presented to a user by the display 24. The user interacts with the web browser 42 via the input devices 26, 28 to navigate to a particular web page 44. The browser application 41 retrieves the web page 44 from the servers 14, 16 via the network 18.

The servers 14, 16 similarly include one or more processors 30, 32 respectively and one or more data storage devices 34, 36 respectively. In various embodiments, the server 14 is a main server that includes a web page manager 38 and the server 16 is a web content server that includes a web content manager 40. The web content manager 40 manages web page content that is stored in the server 16. Such web page content can include, but is not limited to, displayer content such as video player data and ad display data used to generate a video player or an ad displayer of the web page 44, and display data such as video data and ad data that is displayed by the video player or the ad displayer. As can be appreciated, the web page content can include any data that is dynamically displayed by the web page 44.

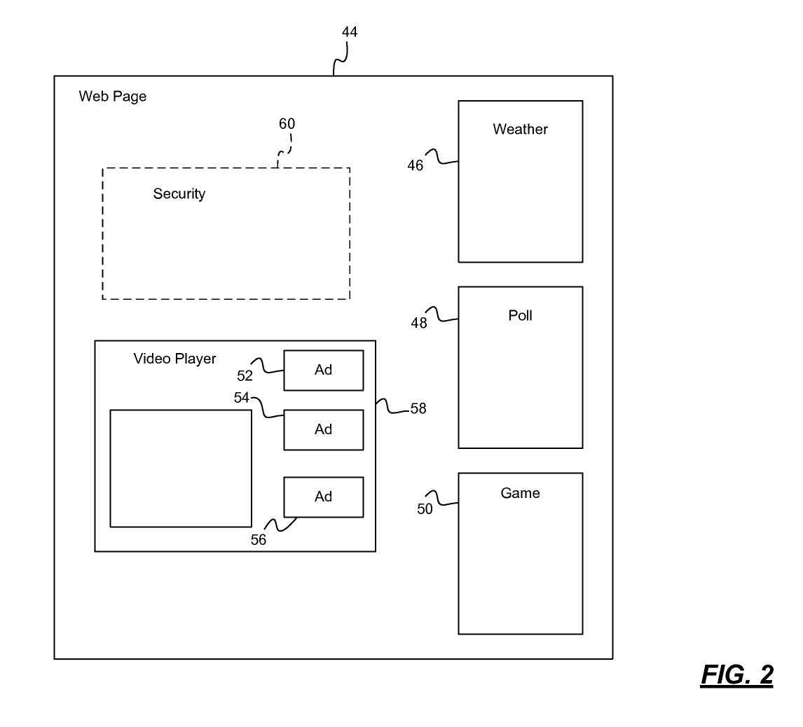

The web page manager 38 manages web page requests that are initiated by a user interacting with the web browser 42. Based on the requests, the web page manager 38 constructs and delivers the web page 44. As shown in FIG. 2, an exemplary web page 44 can include one or more web objects 46-58 and one or more content security managers 60. The web objects 46-58 can include but are not limited to, video player objects 58, advertisement objects 52-56, poll objects 48, game objects 50, and information objects 46 (e.g., weather objects, time objects, calendar objects, etc.). The web objects 46-58 communicate data with each other as well as with the servers 14, 16 (FIG. 1). The content security manager 60 monitors the communications between the web objects 46-58 as well as communications between the web objects 46-58 and the servers 14, 16 (FIG. 1), to identify and report potential threats. In various embodiments, any third party features and/or applications that are not part or local to the web application and provided by a vendor directly or indirectly are tracked, stored, monitored, and/or blocked, if found as a threat and communicated to other computers or servers participating in the security defense mechanism.

With reference back to FIG. 1, to construct the web page 44, the web page manager 38 communicates with the web content manager 40 to retrieve web page content associated with the particular page, constructs the web page 44 based on the displayer content associated with the one or more web objects 46-58 (FIG. 2), embeds the content security manager 60 (FIG. 2) in the web page 44, and delivers the web page 44 to the web browser 42. The web displayer content then communicates with the web content manager 40 to retrieve display data from the server 16. In one example, when the web displayer content is associated with a video player, the display data is video data that is streamed from the server 16. In another example, when the web displayer content is associated with an ad displayer, the display data is ad data that is downloaded from the server 16.

While the web page 44 is being displayed, the content security manager 60 (FIG. 2) monitors communications between the web objects 46-58, between the objects and the servers 14, 16, and/or between the user and the web browser 42. The content security manager 60 (FIG. 2) identifies communications that may generated from a potential threat source, communications that may interfere with the communications between the web objects 46-58, and communications that may interfere with the communications between the web objects 46-58 and the servers 14, 16. The content security manager 60 (FIG. 2) detects, intercepts, and/or reports these communications to safeguard the web page 44.

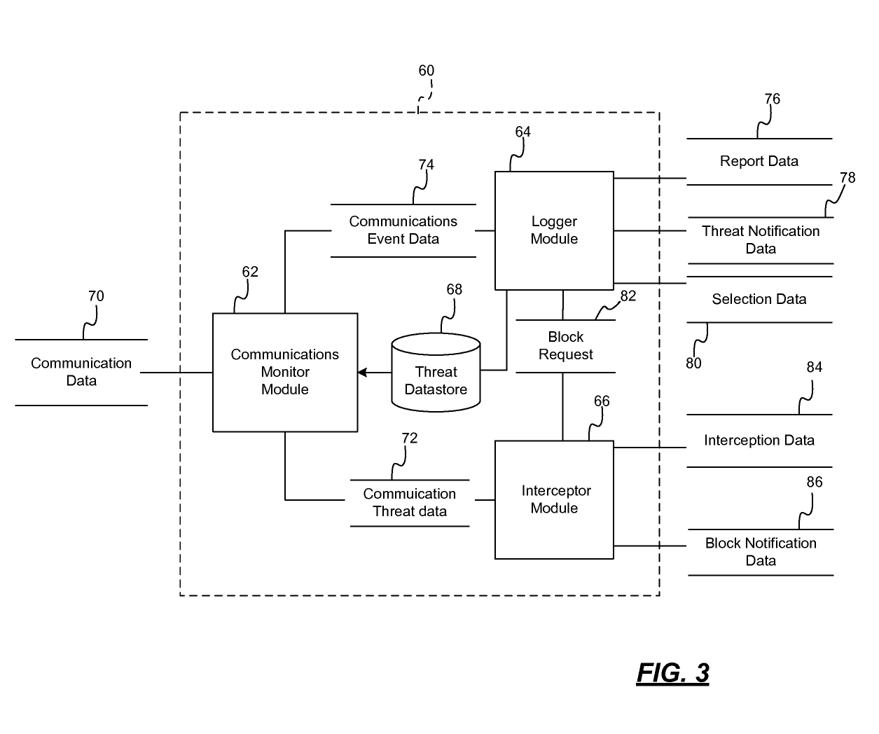

Turning now to FIG. 3, a dataflow diagram illustrates the content security manager 60 of FIG. 2 in more detail in accordance with an exemplary embodiment. The content security manager 60 includes one or more modules and datastores. As can be appreciated, the modules can be implemented as software, hardware, firmware and/or other suitable components that provide the described functionality. As can be appreciated, the modules shown in FIG. 2 can be combined and/or further partitioned to similarly monitor the various communications of the web page 44 (FIG. 1). In this example, the security content manager 60 includes a communications monitor module 62, a logger module 64, an interceptor module 66, and a threat datastore 68. The threat datastore 68 stores information about known threat sources. Such information can include, for example, an IP address, a communication type, a communication pattern, etc.

The communications monitor module 62 receives as input data associated with various types of communications between the web objects themselves and between the web objects and the server, including but not limited to, inter-object communication data, and object-server type communication data. For example, the communication data 70 can include a request to the server 16 (FIG. 1) to populate the video player or the ad displayer with video data or add data.

The communications monitor module 62 monitors the communication data 70 and compares information in the communication data to data stored in the threat datastore 68. If the information matches or is substantially similar to identified threat sources in the threat datastore 68, the communications monitor module 62 generates communication threat data 72 identifying the communicating threat. The communication monitor module 62 generates communication event data 74 associated with the communication threat data 72 for logging purposes. The communication event data can include information indicating the conditions surrounding the communication request, for example, to what object the communication was made and/or from what object or entity the communication was made, etc.

The logger module 64 receives as input the communication event data 74. The logger module 64 generates report data 76 that reports the communications event data or a subset thereof to resources. The reports can be evaluated to determine threat patterns and/or threat sources that are associated with the communication threat data. In various embodiments, the threat datastore 68 can be updated based on the threat patterns and/or threat sources. In the event of a potential threat, respective resources are notified via threat notification data 78 of the vulnerability and given one or more options. In various embodiments, the options include, but are not limited to: reject or cancel the operation; monitor closely the patterns (e.g., when an unknown or new vulnerability is identified); automatically reject/block these requests in the future; trace the internet protocol (IP) address of the vulnerability and block; log the information and share with others; and collaborate with others and take action based thereon.

Selection data 80 is received by the logger module 64 based on a user's selection of one of the options. If in the event the selection data 80 indicates to reject or cancel the operation, to automatically reject/block these requests in the future, or to trace the IP address of the vulnerability and block, the logger module 64 generates a block request 82 accordingly.

The interceptor module 66 receives as input the block request 82, and the communication threat data 72. Based on the block request 82, the interceptor module 66 intercepts the communication and blocks or cancels the associated request via interception data 84. For example, based on the type of block request, the interceptor module 66 can reject the particular operation associated with the request, can automatically block requests associated with this type of communication in the future, and/or block all communications from the particular IP address. In various embodiments, the interceptor module 66 generates a notification via block notification data 86 to the communicating entity when the communication has been intercepted.

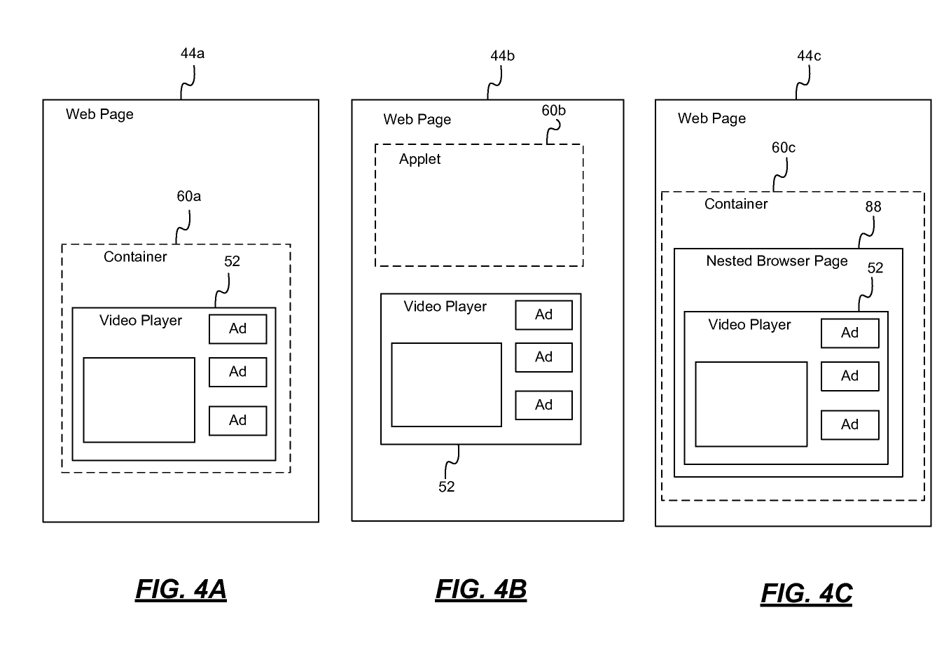

Turning now to FIGS. 4A-4C, various exemplary implementations of the content security manager 60 (FIG. 3) for video player objects 58 are shown. As shown in FIG. 4A, the content security manager 60a can be implemented as a container object that encapsulates the video player objects 58 and that includes event listeners. The event listeners, for example, monitor calls that the video data send to the web browser 42 (FIG. 1), or other web objects 46-56 (FIG. 2). As shown in FIG. 4B, the content security manger 60b can be implemented as an applet that monitors script events associated with the video player 52. As shown in FIG. 4C, the content security manger 60c can be implemented as container, for example, an iFrame container or any other type of container, that houses a nested web page 88. The content security manager 60c captures script communications.

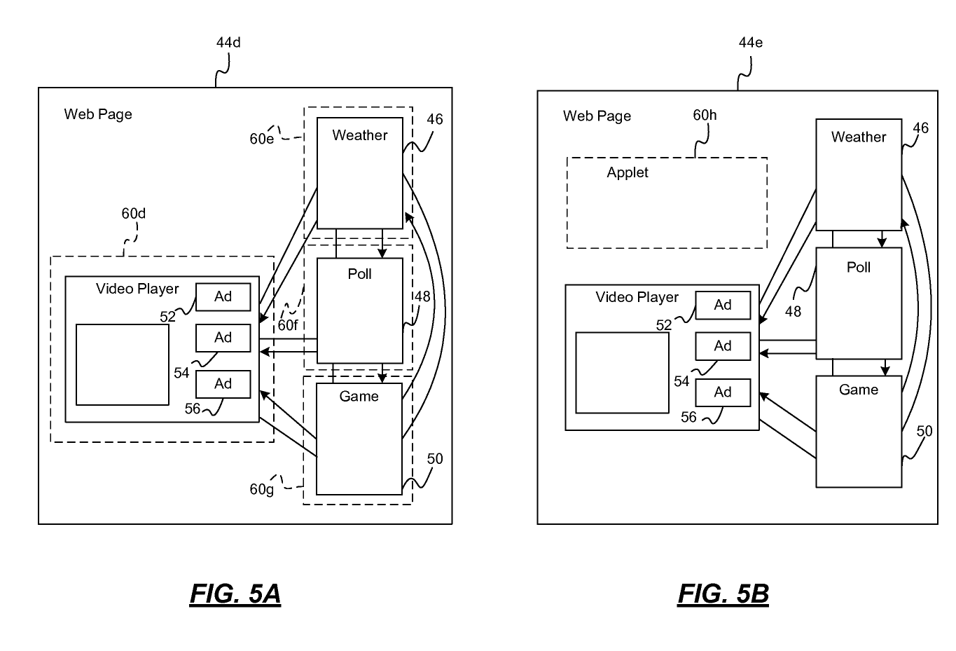

Turning now to FIGS. 5A-5B, various exemplary implementations of the content security manager 60 for web objects 46-56 are shown. As shown in FIG. 5A, the content security manager 60d can be implemented as a container object that monitors or encapsulates the web objects and provides awareness and capturing capabilities regarding JavaScript and other browser communications. In various embodiments, a container object 60e-60h can be provided around each web object 46-56 on the web page 44. Each container object 60e-60h includes JavaScripts that listen for commands. As shown in FIG. 5B, the content security manager 60i can be implemented as an applet that monitors communications between the various web objects 46-56.

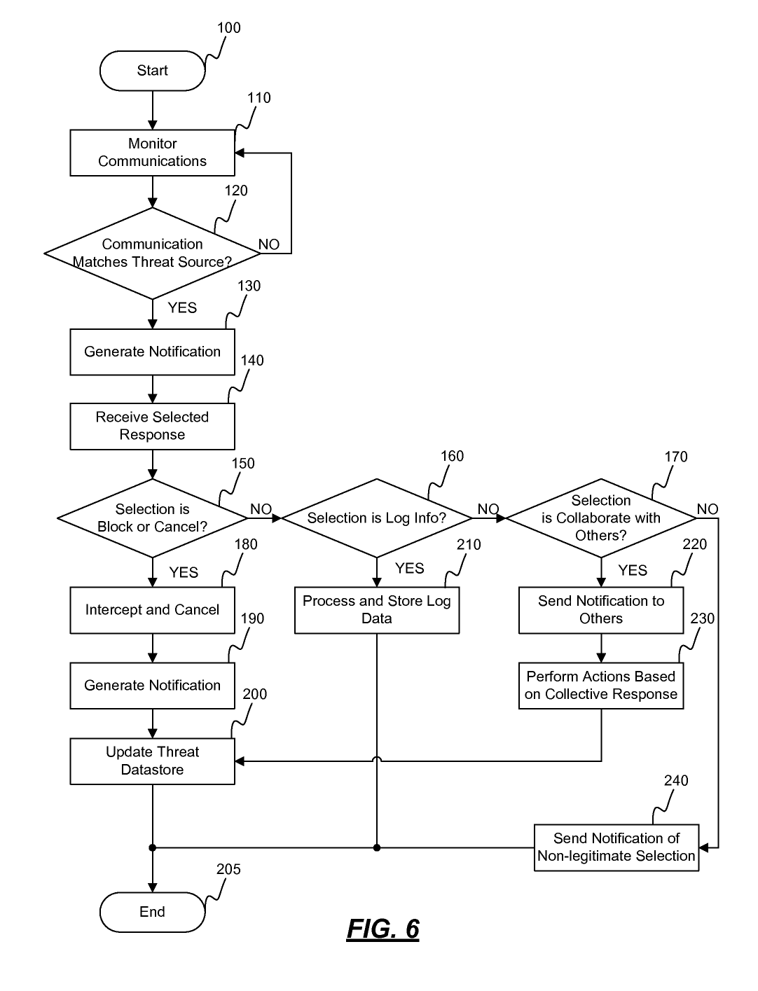

Turning now to FIG. 6, a flow chart illustrates a security method that can be performed by the content security manager 60 of FIG. 3 in accordance with an exemplary embodiment. As can be appreciated in light of the disclosure, the order of operation within the method is not limited to the sequential execution as illustrated in FIG. 6, but may be performed in one or more varying orders as applicable and in accordance with the present disclosure.

In various embodiments, the method is scheduled to run while the web page 44 (FIG. 1) is displayed by the web browser 42 (FIG. 1). In various other embodiments, the method is scheduled to run based on predetermined events and/or at scheduled intervals of time.

In one example, the method may begin at 100. Communications are monitored at 110. The communication information is compared with threat source information at 120. If the communication is a potential threat at 120, a notification is generated to a resource based on the threat type at 130. If, however, the communication is not a threat at 120, the method continues with monitoring the communications at 110.

Upon receiving a selection of an option that is generated by the resource at 140, the selection is evaluated at 150-170. If the selection indicates to block or cancel the communication at 150, based on the block or cancel type the specific communication is intercepted and canceled, and/or any communication from that source is intercepted and canceled 180 and a block notification is generated at 190. Thereafter, the threat datastore 68 (FIG. 3) is updated at 200 and the method may end at 205.

If, however, the selection indicates to log the information for later evaluation at 160, the communication information surrounding the particular threat communication is stored in a log file at 210 and the method may end at 205.

If, however, the selection indicates to collaborate with other resources at 170, a notification is generated to other resources at 220 and actions are taken based on a collective response at 230. The threat datastore 68 (FIG. 3) can optionally be updated based on the collective response at 200 and the method may end at 205.

As one example, one or more aspects of the present disclosure can be included in an article of manufacture (e.g., one or more computer program products) having, for instance, computer usable media. The media has embodied therein, for instance, computer readable program code means for providing and facilitating the capabilities of the present disclosure. The article of manufacture can be included as a part of a computer system or provided separately.

Additionally, at least one program storage device readable by a machine, tangibly embodying at least one program of instructions executable by the machine to perform the capabilities of the present disclosure can be provided.

Computer program code for carrying out operations of the present invention may be written in any combination of one or more programming languages, including an object oriented programming language such as XML, Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A web content security system embedded in a computer-usable storage medium that identifies potential threats when executed by one or more processors, the web content security system comprising:
a communications monitor module that monitors at least one of data communications between web objects on a web page and data communications between web objects on a web page and a server, and that identifies a potential threat based on the data communications; and
a logger module that generates report data based on the identified potential threat.

2. The system of claim 1 wherein the communications monitor module identifies the potential threat based on threat data stored in a threat datastore.

3. The system of claim 2 further comprising the threat datastore.

4. The system of claim 1 further comprising an interceptor module that intercepts data communications and at least one of cancels and blocks the data communications based on the identified potential threats.

5. The system of claim 4 wherein at least one of the interceptor module and the logger module perform, based on the identified potential threat, at least one of cancel an operation associated with the data communication, monitor communication patterns associated with the data communication, automatically block requests associated with the data communications in subsequent data communications, trace an internet protocol (IP) address associated with the data communication and block subsequent data communications from that IP address, log information associated with the data communication, and collaborate with others and take action based on a collective response.

6. The system of claim 1 wherein the logger module further generates a notification indicating the potential threat and one or more threat response options.

7. The system of claim 6 wherein the wherein the logger module updates a threat datastore based on a selection of the one or more threat response options.

8. The system of claim 6 wherein the one or more threat response options includes at lest one of a cancel operation option, a monitor communication patterns option, an automatically block requests in the future option, a trace an associated internet protocol (IP) address and block option, a log associated information option, and a collaborate with others option.

9. A method of identifying a potential threat to a web page, comprising:
performing on a processor,
monitoring at least one of data communications between web objects on a web page and data communications between web objects on a web page and a server;
identifying the potential threat based on the data communications; and
generating report data based on the identified potential threat.

10. The method of claim 9 wherein the report data includes a notification indicating the potential threat and one or more threat response options.

11. The method of claim 9 wherein the identifying the potential threat is further based on a comparison of information associated with the data communications with threat information stored in a threat datastore.

12. The method of claim 9 further comprising canceling an operation associated with the data communication based on the potential threat.

13. The method of claim 9 further comprising monitoring communication patterns associated with the data communication based on the potential threat.

14. The method of claim 9 further comprising automatically blocking requests associated with the data communication in subsequent data communications based on the potential threat.

15. The method of claim 9 further comprising tracing an internet protocol (IP) address associated with the data communication and block subsequent data communications from that IP address based on the potential threat.

16. The method of claim 9 further comprising logging information associated with the data communication based on the potential threat.

17. The method of claim 9 further comprising collaborating with other resources and taking action based on a collective response based on the potential threat.

18. A web page embedded in a computer-usable storage medium that identifies potential threats when executed by one or more processors, the web page comprising:
a web object embedded in the web page; and
a content security manager embedded in the web page that that monitors data communications between the web object and a server, and that identifies a potential threat based on the data communications.

19. The web page of claim 18 further comprising a plurality of web objects embedded on the web page, and wherein the content security manager monitors data communications between the plurality of web objects and identifies the potential threat based on the data communications between the plurality of web objects.

20. The web page of claim 18 wherein the content security manager perform, based on the identified potential threat, at least one of, cancel an operation associated with the data communication, monitor communication patterns associated with the data communication, automatically block requests associated with the data communications in subsequent data communications, trace an internet protocol (IP) address associated with the data communication and block subsequent data communications from that IP address, log information associated with the data communication, and collaborate with others and take action based on a collective response.

21. The web page of claim 18 wherein the content security manager maintains a threat datastore that stores information associated with the potential threats.

22. The web page of claim 18 wherein the content security manager module identifies the potential threat based on a comparison of information associated with the data communication with data in a threat datastore.

23. The web page of claim 18 wherein the web object is a video player object.

24. The web page of claim 18 wherein the web object is at least one of an advertisement object, a poll object, a game object, and an information object.

25. The web page of claim 18 wherein the content security manager is implemented as a container object of the web page.

26. The web page of claim 18 wherein the content security manager is implemented as an applet of the web page.

27. The web page of claim 18 wherein the content security manager is implemented as a frame object of the web page.
